(19) United States
(12) Patent Application Publication
(10) Pub. No.: US 2026/0370629 A1
(43) Pub. Date: Nov. 19, 2026

(54) Artificial Intelligence Context Protocol Proxy Service

(71) Applicant: Microsoft Technology Licensing, LLC, Redmond, WA (US)

(72) Inventor: Samuel Edward SCHILLACE, Portola Valley, CA (US)

(73) Assignee: Microsoft Technology Licensing, LLC, Redmond, WA (US)

(21) Appl. No.: 19/212,591

(22) Filed: May 19, 2025

(51) Int. Cl. H04L 9/40

(52) U.S. Cl. CPC H04L 63/0281; H04L 63/123; H04L 63/20

(57) ABSTRACT

A computing system including one or more processing devices configured to receive an artificial intelligence context protocol (AICP) endpoint search query from a generative system executed at an AICP client. The one or more processing devices select an AICP endpoint that matches the AICP endpoint search query from among a plurality of AICP endpoints. At an AICP proxy service, the one or more processing devices send and receive AICP traffic between the AICP client and the AICP endpoint. The AICP traffic includes one or more AICP requests and responses. The one or more processing devices enforce a request policy on the one or more AICP requests, and/or a response policy on the one or more AICP responses. At one or more ML models included in the generative system, the one or more processing devices compute and output a generated output based at least on the one or more AICP responses.

### BACKGROUND

In some machine learning (ML) systems, an ML model included in the ML system is equipped with the ability to make calls to one or more external tools or resources. The ML model may receive input data from one or more of these external tools or resources or may generate an output that includes control instructions for an external application program. For example, the ML model may output instructions to execute other computing processes such as database lookup operations to interact with other application programs such as a web browser or a word processing application program. These external tools and resources accordingly extend the capabilities of the ML system beyond those of the ML model alone.

### SUMMARY

According to one aspect of the present disclosure, a computing system is provided, including one or more processing devices configured to receive an artificial intelligence context protocol (AICP) endpoint search query from a generative system executed at an AICP client. The generative system includes one or more machine learning (ML) models. The one or more processing devices are further configured to select an AICP endpoint that matches the AICP endpoint search query from among a plurality of AICP endpoints. At an AICP proxy service, the one or more processing devices are further configured to send and receive AICP traffic between the AICP client and the selected AICP endpoint. The AICP traffic includes one or more AICP requests and one or more AICP responses. The one or more processing devices are further configured to enforce a request policy on the one or more AICP requests, and/or enforce a response policy on the one or more AICP responses. At the one or more ML models included in the generative system, the one or more processing devices are further configured to compute a generated output based at least in part on the one or more AICP responses. The one or more processing devices are further configured to output the generated output.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 schematically shows a computing system at which an artificial intelligence context protocol (AICP) is implemented, according to one example embodiment.

FIG. 2 schematically shows the computing system when an endpoint search module and an AICP proxy service are executed, according to the example of FIG. 1.

FIG. 3 schematically shows the computing system in further detail when a request policy is enforced at the AICP proxy service, according to the example of FIG. 2.

FIG. 4 schematically shows the computing system in further detail when a response policy is enforced at the AICP proxy service, according to the example of FIG. 2.

FIG. 5 schematically shows the computing system during registration of an AICP endpoint with the AICP proxy service, according to the example of FIG. 2.

FIG. 6 schematically shows the computing system when the one or more processing devices are configured to perform traffic shaping at the AICP proxy service, according to the example of FIG. 2.

FIG. 7A shows a flowchart of a method for use with a computing system to search for one or more AICP endpoints and implement an AICP proxy service, according to the example of FIG. 1.

FIGS. 7B-7F show additional steps of the method of FIG. 7A that may be performed in some examples.

FIG. 8 shows a schematic view of an example computing environment in which the computing system of FIG. 1 may be instantiated.

### DETAILED DESCRIPTION

Artificial intelligence context protocols (AICPs) have recently been developed to allow ML systems to exchange inputs and outputs with external tools and resources in a consistent and standardized manner. An AICP is an application layer protocol in the open services interconnection (OSI) model of client-server communications that facilitates interaction between ML systems, as clients, and external services, as servers. An AICP endpoint refers to a server program operating at a network address that is configured with an application-programming interface (API) for the external service. The external service is thus a hosted application at the endpoint. The service is external to the ML system but may be hosted locally on the same computing device or remotely on a separate computing device. An AICP provides a shared communication framework by which data such as ML model contexts and inferencing outputs may be exchanged between an AICP client that executes the ML system and one or more AICP servers outside the ML system. Model Context Protocol (MCP) is an example of an AICP that has recently seen increased adoption among providers both of ML systems and of external tools made available to those ML systems.

Connections between an ML system and external endpoints over an AICP may present challenges related to cybersecurity. For example, an AICP server may provide a malicious tool to ML systems. This malicious tool may output instructions for the ML system to perform an unwanted action or may utilize received ML system data in an unwanted manner. The malicious tool may, in some examples, be configured to spoof a legitimate external tool. As another example of a cybersecurity concern, the ML system may leak confidential data by transmitting that data to an external application over the AICP.

In order to address cybersecurity challenges that may occur when using an AICP, systems and methods of implementing an AICP proxy service are provided. The AICP proxy service acts as a layer between an AICP client and an AICP server that enforces a request policy and/or a response policy on traffic exchanged over the AICP. In some examples, the AICP proxy service may additionally or alternatively be used to perform traffic shaping on AICP requests and responses.

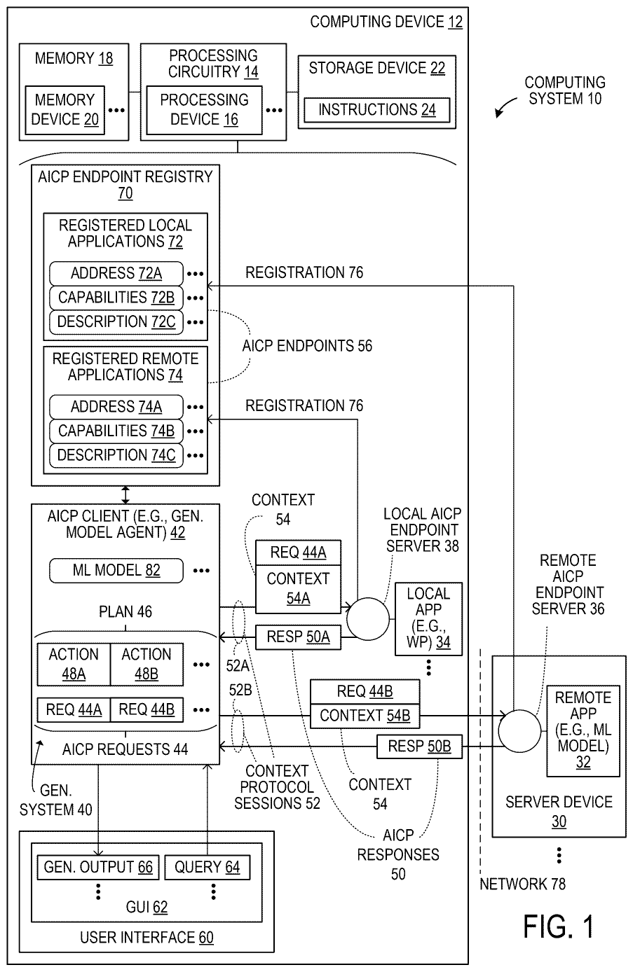

FIG. 1 schematically shows a computing system 10 at which an AICP is implemented. The computing system 10 includes a computing device 12 having processing circuitry 14, memory 18, and a storage device 22 storing instructions 24 that enable the processing circuitry 14 to perform the functions described herein. The processing circuitry 14 includes one or more processing devices 16, which may, for example, include one or more central processing units (CPUs), graphics processing units (GPUs), neural processing units (NPUs), and/or other specialized hardware accelerator devices. The memory 18 may include one or more memory devices 20.

While illustrated as a single computing device 12 in FIG. 1, it will be understood that the computing device 12 can be a distributed computing device 12, and that the processing circuitry 14, memory 18, and storage device 22 of this implementation may be distributed among a plurality of physical devices connected by a computer network, with coordinated operations being performed among these devices in a distributed computing environment. For example, in a virtualized environment, storage, processing, and memory can be implemented on different physical machines. As another example, computing device 12 may utilize client software that interacts with cloud services. Thus, one or more functions described herein may be executed on a remote server.

The one or more processing devices 16 included in the computing device 12 are configured to execute a generative system 40 at an AICP client 42. The generative system 40 includes one or more ML models 82, such as one or more generative language models, text-to-image (T2I) models, image-to-text (I2T) models, audio generation models, audio transcription models, classifier models, multimodal ML models, and/or other types of ML models. The generative system 40 may further include scaffolding code associated with the one or more ML models 82. For example, the scaffolding code may be executed to select one or more of the ML models 82 from among a plurality of ML models 82 included in the generative system 40. The scaffolding code may additionally or alternatively be executed to specify a context used as an inferencing input to an ML model 82, and/or to post-process an inferencing output.

In the example of FIG. 1, the computing device 12 is a client computing device that is configured to communicate with a server device 30 over a network 78. The AICP client 42 is configured to transmit AICP request 44 to a remote application program 32 executed at the server device 30 and is configured to receive AICP responses 50 from that remote application program 32. In some examples, the AICP client 42 may additionally be configured to communicate with one or more local application programs 34 hosted at the computing device 12. For example, the local application program 34 may be a word processing program and the remote application program may be a remotely hosted ML model.

In the example of FIG. 1, the computing device 12 and the server device 30 are accordingly configured to instantiate a remote AICP endpoint server 36 and a local AICP endpoint server 38, respectively, as virtual endpoint servers of the AICP. The one or more processing devices 16 are configured to instantiate a plurality of context protocol sessions 52 in this example. The AICP client 42 is configured to communicate with the local AICP endpoint server 38 over a first context protocol session 52A and communicate with the remote AICP endpoint server 36 over a second context protocol session 52B.

In the example of FIG. 1, the one or more processing devices 16 are further configured to implement a user interface 60 at which the user communicates with the generative system 40 using one or more input devices and one or more output devices. For example, the user interface 60 may include a graphical user interface (GUI) 62. One or more other input modalities and/or output modalities, such as speech input and audio output, may also be exchanged at the user interface 60 in some examples. At the user interface 60, the one or more processing devices 16 are configured to receive one or more queries 64 entered by the user. In response to the one or more queries 64, the one or more processing devices 16 are further configured to compute one or more generated outputs 66 at the generative system 40 and output the one or more generated outputs 66 to the user interface 60. For example, the user interface 60 may be presented in a chat format in which the user and the generative system 40 send and receive the one or more queries 64 and the one or more generated outputs 66 as conversational turns.

The generative system 40, in the example of FIG. 1, is configured to compute a plan 46 at least in part at the one or more ML models 82 in response to receiving a query 64 from the user interface 60. For example, the plan 46 may be computed at a generative language model configured to generate computer code. The example plan 46 shown in FIG. 1 includes a first action 48A and a second action 48B that the one or more processing devices 16 are configured to execute at least in part by communicating with the local AICP endpoint server 38 and the remote AICP endpoint server 36. For example, the generative system 40 may compute the plan 46 in response to a user query that includes a link to a text document and an instruction “highlight all the passages in this document that have spelling mistakes, grammatical mistakes, or unclear wording.” In this example, the first action 48A may be executed at least in part at a locally hosted word processing application and the second action 48B may be executed at least in part at a remotely hosted generative language model.

At the AICP client 42, the one or more processing devices 16 are further configured to compute AICP requests 44 including a first AICP request 44A and a second AICP request 44B. Over the first context protocol session 52A and the second context protocol session 52B, respectively, the one or more processing devices 16 are further configured to transmit the first AICP request 44A to the local AICP endpoint server 38 and transmit the second AICP request 44B to the remote AICP endpoint server 36. The one or more processing devices 16 are further configured to compute context 54 at the generative system 40 and transmit that context 54 to the endpoint servers. For example, the context 54 may include data indicated as an inferencing input for an ML model located at an AICP endpoint server. Additionally or alternatively, the context 54 may include at least a portion of the plan 46. In the example of FIG. 1, the first AICP request 44A is transmitted to the local AICP endpoint server 38 along with a first context 54A, and the second AICP request 44B is transmitted to the remote AICP endpoint server 36 along with a second context 54B.

The AICP client 42 is further configured to receive AICP responses 50 including a first AICP response 50A and a second AICP response 50B. The first AICP response 50A is received from the local AICP endpoint server 38 via the first context protocol session 52A, and the second AICP response 50B is received from the remote AICP endpoint server via the second context protocol session 52B.

At the one or more ML models 82 included in the generative system 40, the one or more processing devices 16 are further configured to compute the generated output 66 based at least in part on the one or more AICP responses 50. The one or more processing devices 16 are further configured to output the generated output 66 to the user interface 60 as a response to the user's query 64. Additionally or alternatively, the one or more processing devices 16 may be configured to output the generated output 66 to some other computing process, such as a data logging process or an ML model training process.

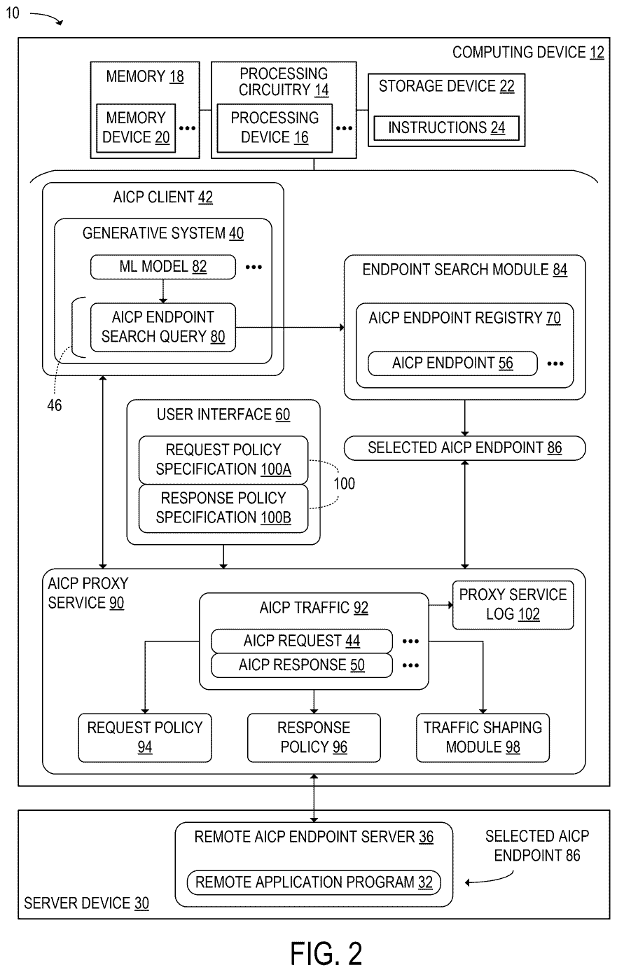

Turning now to FIG. 2, the computing system 10 is depicted in an example in which an endpoint search module 84 and an AICP proxy service 90 are executed. At the endpoint search module 84, the one or more processing devices 16 are configured to receive an AICP endpoint search query 80 from the generative system 40. For example, the AICP endpoint search query 80 may be included in the plan 46 generated in response to the user query 64 and may indicate an action that the generative system 40 is configured to offload to an AICP endpoint. At the endpoint search module 84, the one or more processing devices 16 are further configured to select, from among a plurality of AICP endpoints 56, an AICP endpoint 86 that matches the AICP endpoint search query 80. For example, the one or more processing devices 16 may be configured to perform a vector similarity search over the capabilities 72B and 74B and the descriptions 72C and 74C of the registered local applications 72 and the registered remote applications 74 in order to select the AICP endpoint 86.

Returning to the example of FIG. 1, the storage device 22 of the computing device 12 further stores an AICP endpoint registry 70. The AICP endpoint registry 70 includes respective indications of one or more registered local applications 72 and registered remote applications 74. As discussed in further detail below, the AICP endpoint registry 70 may be a registry of AICP endpoints 56 registered with the AICP proxy service 90. Each of the registered local applications 72 may be indicated in the AICP endpoint registry 70 with a corresponding address 72A, list of capabilities 72B, and description 72C. Similarly, each of the registered remote applications 74 may be indicated with a corresponding address 74A, list of capabilities 74B, and description 74C. The addresses 72A and 74A may, for example, be Internet protocol (IP) addresses. The lists of capabilities 72B and 74B may be organized according to a predefined schema and may include a corresponding name and textual description for each of the capabilities listed. The descriptions 72C and 74C may be textual descriptions of the registered local applications 72 and registered remote applications 74.

In the example of FIG. 2, when the one or more processing devices 16 execute the endpoint search module 84 to process the AICP endpoint search query 80, the one or more processing devices 16 may be configured to select the AICP endpoint 86 from among the plurality of AICP endpoints 56 included in the AICP endpoint registry 70. Accordingly, the one or more processing devices 16 may select an AICP endpoint 56 that has been verified as safe in a testing process performed at the AICP proxy service 90, as discussed in further detail below.

Subsequently to selecting the AICP endpoint 86, the one or more processing devices 16 are further configured to send and receive AICP traffic 92 between the AICP client 42 and the selected AICP endpoint 86 at the AICP proxy service 90. The AICP traffic 92 includes one or more AICP requests 44 and one or more AICP responses 50, as discussed above. In the example of FIG. 2, the selected AICP endpoint 86 with which the one or more processing devices 16 are configured to send and receive the AICP traffic 92 is the remote AICP endpoint server 36 executed at the server device 30.

In some examples, sending and receiving the AICP traffic 92 between the AICP client 42 and the selected AICP endpoint 86 may include performing network address translation (NAT) at the AICP proxy service 90. In examples in which the one or more processing devices 16 are configured to perform NAT, subsequently to receiving the AICP request 44 from the AICP client 42, the one or more processing devices 16 may be configured to read a destination network address of the selected AICP endpoint 86 from a header of the AICP request 44. The one or more processing devices 16 may be further configured to perform a table lookup in a NAT table to determine whether to translate the destination network address into a modified destination network address. The one or more processing devices 16 may be further configured to translate the destination network address into the modified destination network address when instructed to do so by the NAT table.

At the AICP proxy service 90, the one or more processing devices 16 are further configured to enforce a request policy 94 on the one or more AICP requests 44, and/or enforce a response policy 96 on the one or more AICP responses 50. The request policy 94 may be a computing process that filters AICP requests 44 such that an AICP request 44 is blocked if that AICP request 44 does not comply with a predetermined policy. Similarly, the response policy 96 may be a computing process that filters AICP responses 50 to block AICP responses 50 that do not comply with a predetermined policy. In some examples, enforcing the request policy 94 or the response policy 96 may additionally or alternatively include modifying one or more AICP requests 44 or AICP responses 50 that do not comply with a predetermined policy to obtain one or more modified requests or responses that comply with the policy. For example, at the AICP proxy service 90, the one or more processing devices 16 may modify an AICP request 44 that indicates an unregistered AICP endpoint 56 as its destination to instead indicate a registered AICP endpoint 56 included in the AICP endpoint registry 70. As another example, the one or more processing devices 16 may be configured to remove an untrusted portion of an AICP response 50 without blocking the entire response.

In some examples, enforcing the request policy 94 and/or the response policy 96 at the AICP proxy service 90 may include performing deep packet inspection on an AICP request 44 and/or an AICP response 50. To perform deep packet inspection on an AICP request 44, the one or more processing devices 16 may be configured to decrypt a payload of the AICP request 44. The one or more processing devices 16 may be further configured to inspect the payload of the AICP request 44 by determining whether the decrypted payload satisfies the request policy 94. In examples in which the AICP client 42 transmits chunked data to the selected AICP endpoint 86 over a plurality of AICP requests 44, the one or more processing devices 16 may be configured to inspect the plurality of AICP requests 44 together when determining whether those AICP requests satisfy the request policy 94. To enforce the request policy 94, the one or more processing devices 16 may be configured to perform one or more operations such as blocking an AICP request 44, deleting or rewriting at least a portion of the payload of an AICP request 44, performing NAT on the AICP request 44, and/or performing traffic shaping on a plurality of AICP requests 44. Subsequently to enforcing the request policy 94 at the AICP proxy service 90, the one or more processing devices 16 may be further configured to re-encrypt the payload (as modified, in examples in which a modification to the payload has been performed) and the header (also with one or more modifications when applicable). The one or more processing devices 16 are further configured to transmit the re-encrypted AICP request 44 to the selected AICP endpoint 86.

Although the above example discusses deep packet inspection with reference to an outgoing AICP request 44, deep packet inspection may additionally or alternatively be performed on an AICP response 50 received from the selected AICP endpoint 86. In such examples, similar techniques of decryption, response policy enforcement, and re-encryption may be performed at the AICP proxy service 90.

In some examples, the one or more processing devices 16 may be further configured to receive a proxy policy specification 100 via the user interface 60. The proxy policy specification 100 may be a request policy specification 100A that defines at least a portion of the request policy 94 or a response policy specification 100B that defines at least a portion of the response policy 96. The one or more processing devices 16 may be further configured to enforce the request policy 94 and/or the response policy 96 at the AICP proxy service 90 as specified by the proxy policy specification 100. Accordingly, the user may define the request policy 94 and/or the response policy 96.

In some examples, when the AICP traffic 92 includes a plurality of AICP requests 44 and a plurality of AICP responses 50, the one or more processing devices 16 may be further configured to execute a traffic shaping module 98 at the AICP proxy service 90. Thus, the one or more processing devices 16 may perform traffic shaping on the plurality of AICP requests 44 and the plurality of AICP responses 50 in order to reduce latency and avoid bottlenecks in the processing of the AICP requests 44 and AICP responses 50.

In some examples, at the AICP proxy service 90, the one or more processing devices 16 are further configured to store the AICP traffic 92 in a proxy service log 102. The one or more processing devices 16 may accordingly retain the AICP traffic 92 for purposes such as monitoring or compliance.

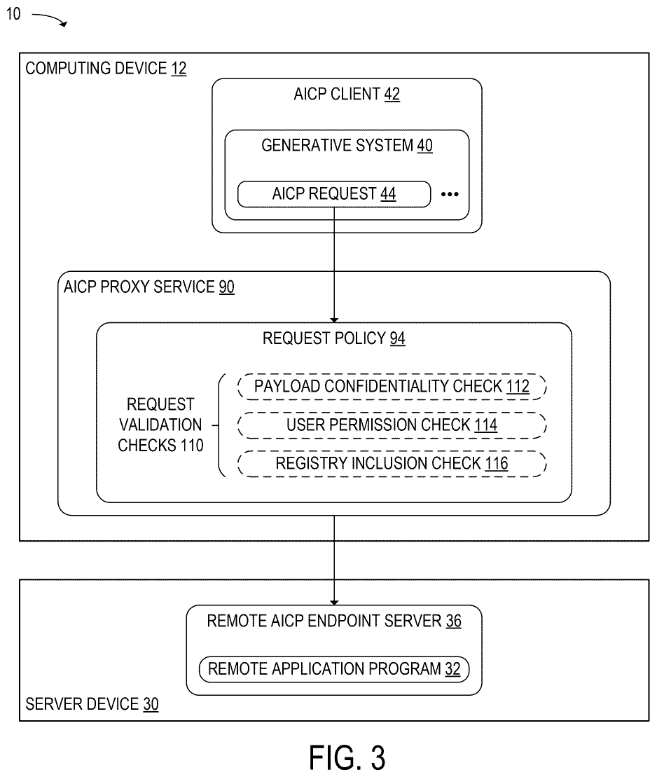

FIG. 3 schematically shows the computing system 10 in further detail when a request policy 94 is enforced at the AICP proxy service 90. At the AICP proxy service 90, the one or more processing devices 16 are configured to enforce the request policy 94 at least in part by performing one or more corresponding request validation checks 110 on the one or more AICP requests 44. For example, the one or more request validation checks 110 may include a payload confidentiality check 112 that is performed by determining whether a request payload of the AICP request 44 is marked as confidential. In such examples, when the request payload is marked as confidential, the one or more processing devices 16 may be configured to prevent the AICP request 44 from being transmitted or may reduce the set of AICP endpoints 56 to which the AICP client 42 is eligible to transmit the AICP request 44.

As another example, the one or more request validation checks 110 may include a user permission check 114. In such examples, the one or more processing devices 16 may be configured to determine whether a user whose query 64 initiates the AICP request 44 at the generative system 40 has a credential permitting the user to prompt the generative system 40 to output the AICP request 44. The user permission check 114 may, for example, be used to enforce permission controls on which users can prompt the generative system 40 access data stored in a remote database provided as an AICP endpoint 56.

In some examples, the one or more request validation checks 110 may include a registry inclusion check 116. In such examples, the one or more processing devices 16 are configured to enforce the request policy 94 at least in part by determining whether the selected AICP endpoint 86 is included in the AICP endpoint registry 70.

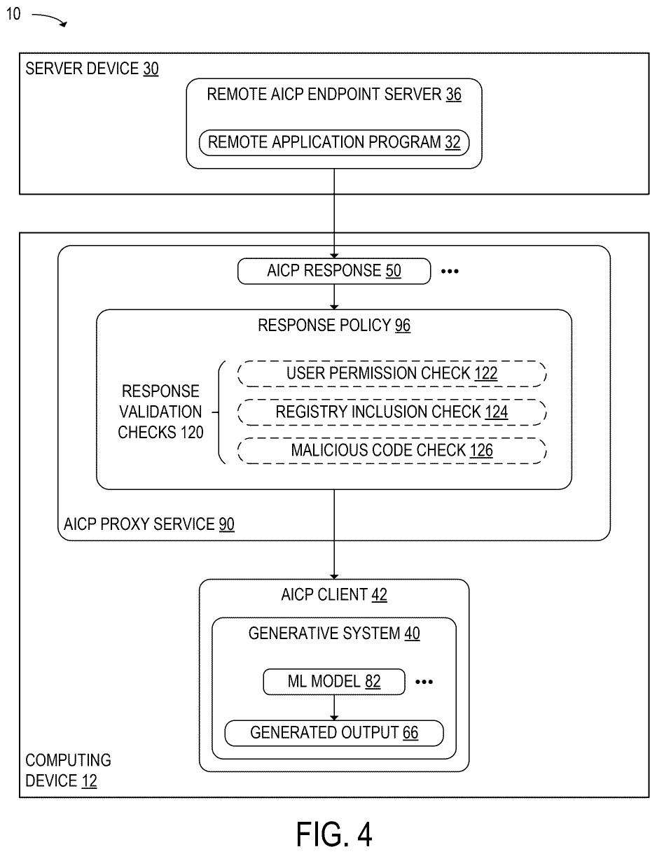

FIG. 4 schematically shows the computing system 10 in additional detail when a response policy 96 is enforced at the AICP proxy service 90. At the AICP proxy service 90, the one or more processing devices 16 are configured to enforce the response policy 96 at least in part by performing one or more corresponding response validation checks 120 on the one or more AICP responses 50. In some examples, the one or more response validation checks 120 may include a user permission check 122. In such examples, the one or more processing devices 16 may be further configured to determine whether the user whose query 64 initiates the AICP request 44 corresponding to the AICP response 50 has a credential permitting the user to receive outputs generated using the remote AICP endpoint server 36. For example, the selected AICP endpoint 86 that transmits the AICP response 50 to the computing device 12 may store a confidential database that only a subset of users of the generative system 40 are allowed to use to compute generated outputs 66.

In some examples, the one or more response validation checks 120 may further include a registry inclusion check 124. In such examples, the one or more processing devices 16 are configured to enforce the response policy 96 at least in part by determining whether the selected AICP endpoint 86 from which the one or more processing devices 16 receive the response 50 is included in the AICP endpoint registry 70. The one or more processing devices 16 may accordingly be configured to check for AICP endpoint spoofing.

In some examples, the one or more response validation checks 120 may further include a malicious code check 126. For example, the one or more processing devices 16 may be configured to execute a classifier ML model that classifies the AICP response 50 according to an estimated probability that the AICP response 50 includes malicious code. A generative language model may be used as the classifier ML model in such examples.

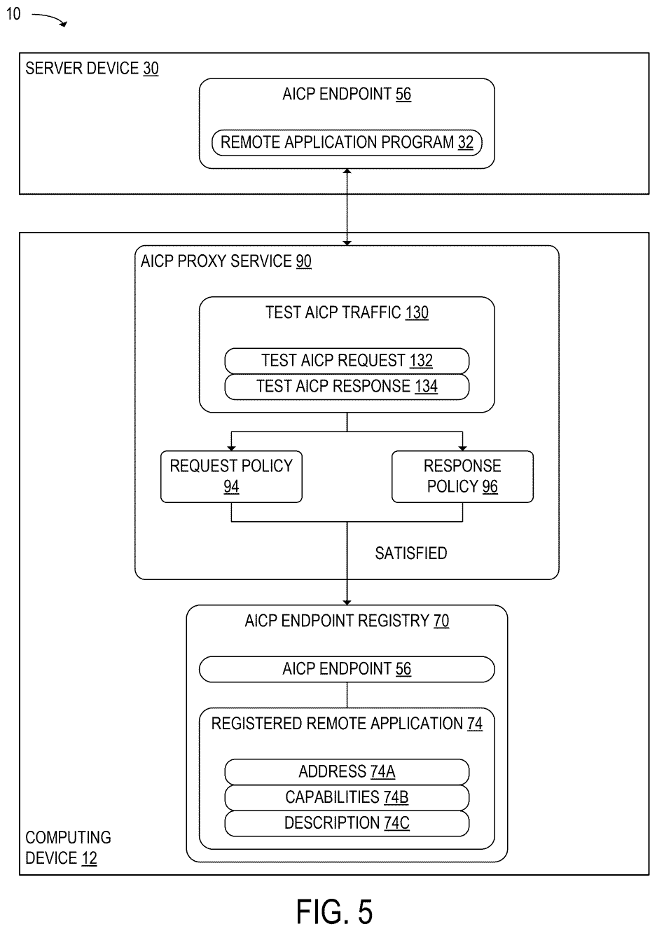

FIG. 5 schematically shows the computing system 10 during registration of an AICP endpoint 56 with the AICP proxy service 90. In this example, the one or more processing devices 16 are configured to register the AICP endpoint 56 with the AICP proxy service 90 at least in part by sending and receiving test AICP traffic 130 between the AICP proxy service 90 and the AICP endpoint 56. The test AICP traffic 130 includes a plurality of test AICP requests 132 and a plurality of test AICP responses 134. In some examples, the test AICP requests 132 may be included in a predetermined set of test AICP requests, which may, for example, be used at the AICP proxy service 90 to test a specific type of AICP endpoints 56.

The one or more processing devices 16 are further configured to determine whether the test AICP traffic 130 satisfies the request policy 94 and/or the response policy 96. In response to determining that the test AICP traffic 130 satisfies the request policy 94 and/or the response policy 96, the one or more processing devices 16 are further configured to register the AICP endpoint 56 with the AICP proxy service 90. Accordingly, the AICP endpoint 56 shown in the example of FIG. 5 is added to the AICP endpoint registry 70 as a registered remote application 74. The one or more processing devices 16 are further configured to store the address 74A, the capabilities 74B, and the description 74C of the AICP endpoint 56 in the AICP endpoint registry 70. By registering a plurality of AICP endpoints 56 as shown in FIG. 5, the one or more processing devices 16 may be configured to identify a set of AICP endpoints 56 that comply with the request policy 94 and/or the response policy 96 and that may be later used to extend the capabilities of the generative system 40 in a manner that is more secure than using untested AICP endpoints 56.

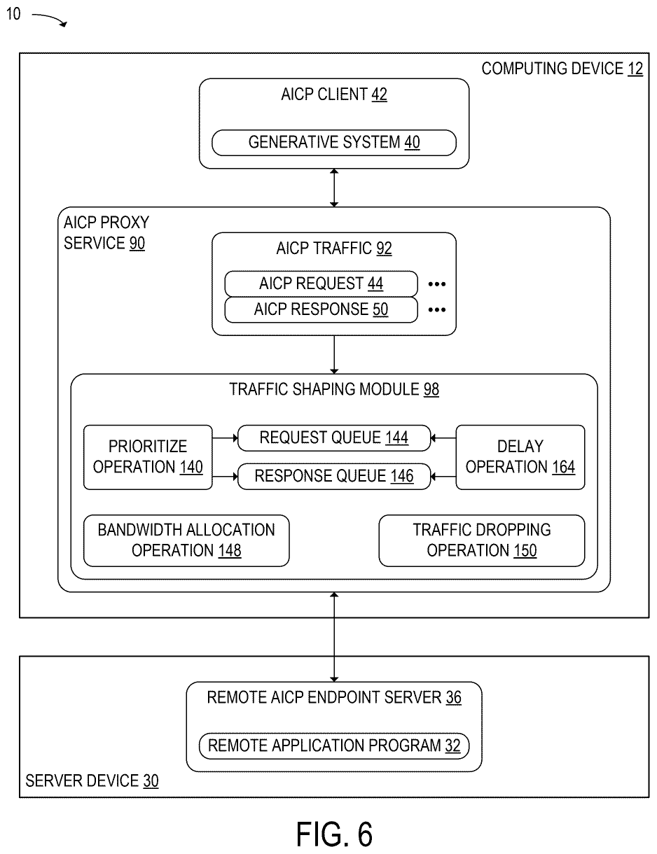

FIG. 6 schematically shows the computing system 10 in an example in which the one or more processing devices 16 are configured to perform traffic shaping at the AICP proxy service 90. The one or more processing devices 16 are configured to execute a traffic shaping module 98 on a plurality of AICP requests 44 and/or AICP responses 50 that are transmitted between the AICP client 42 and the remote AICP endpoint server 36.

The traffic shaping module 98 may, for example, apply a prioritize operation 140 to at least a portion of the AICP traffic 92. The prioritize operation 140 moves one or more of the AICP requests 44 forward in a request queue 144 or moves one or more of the AICP responses 50 forward in a response queue 146. Additionally or alternatively, the traffic shaping module 98 may apply a delay operation 142 that moves one or more of the AICP requests 44 backward in the request queue 144 or moves one or more of the AICP responses 50 backward in the response queue 146.

In some examples, the one or more processing devices 16 may be configured to perform a bandwidth allocation operation 148 at the traffic shaping module 98. The bandwidth allocation operation 148 may distribute communication bandwidth of the AICP client 42 between a plurality of different remote AICP endpoint servers 36. In some examples, the one or more processing devices 16 may be further configured to perform a traffic dropping operation 150 at the traffic shaping module 98. For example, the traffic dropping operation 150 may be performed in response to receiving AICP responses 50 from a specific remote AICP endpoint server 36 at a rate that exceeds a predetermined threshold. The bandwidth allocation operation 148 and/or the traffic dropping operation 150 may accordingly be performed to prevent delays associated with overloading of the AICP client 42.

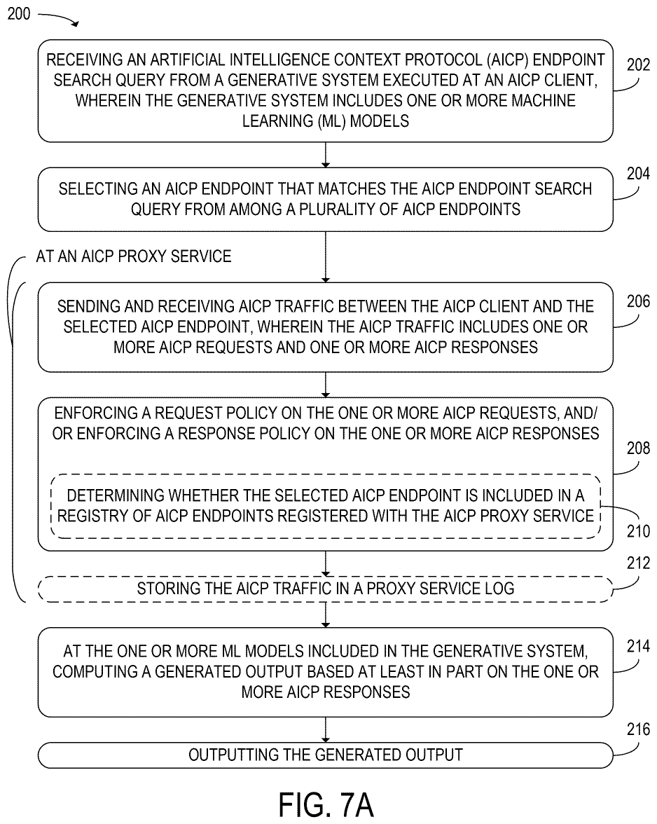

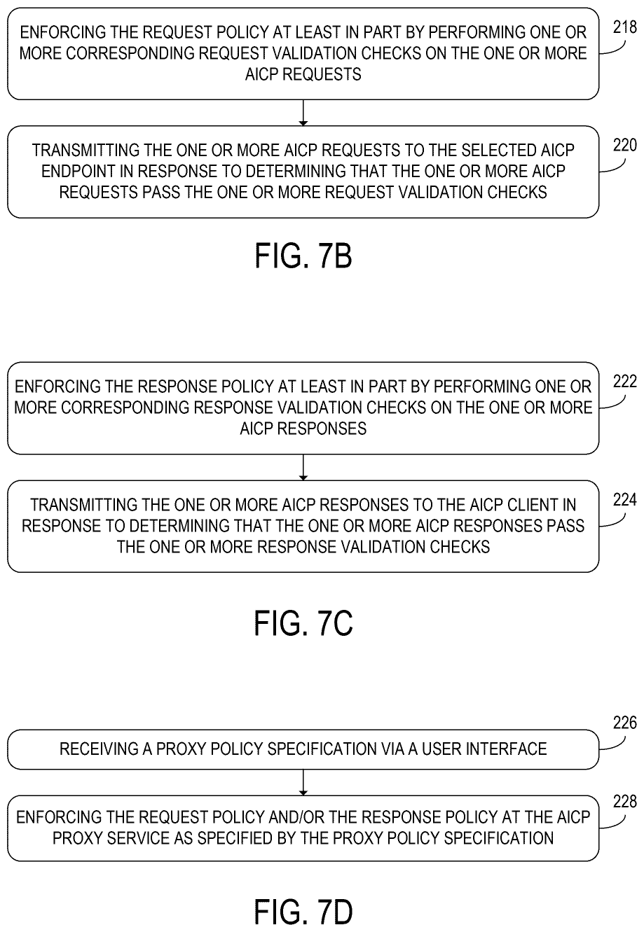

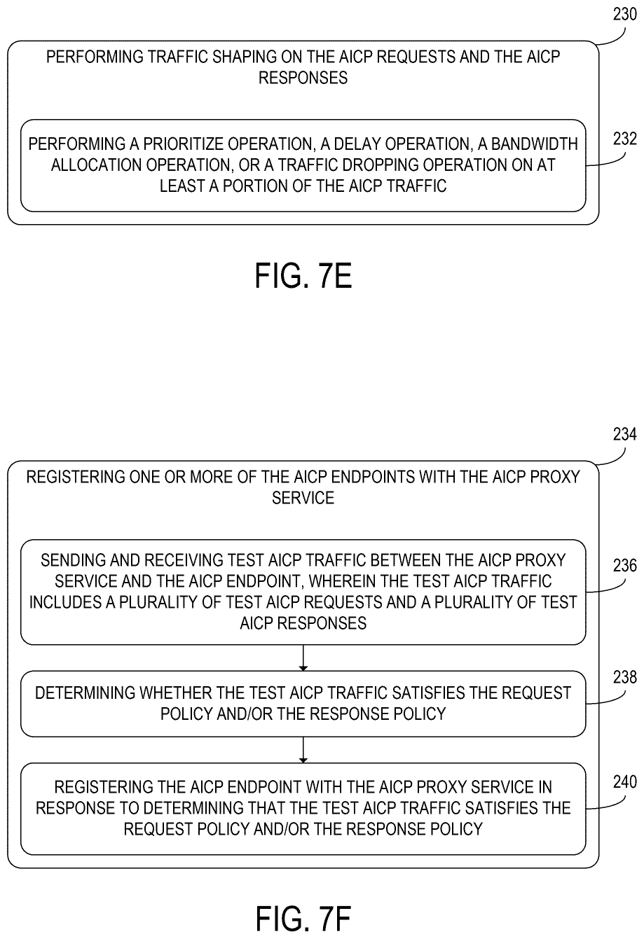

FIG. 7A shows a flowchart of a method 200 for use with a computing system to search for one or more AICP endpoints and implement an AICP proxy service. At step 202, the method 200 includes receiving an AICP endpoint search query from a generative system executed at an AICP client. The generative system includes one or more ML models. The AICP endpoint search query may be generated at least in part at the one or more ML models, for example, as a portion of a plan computed in response to receiving a user query at the generative system. The AICP endpoint search query may indicate one or more actions that are configured to be executed at least in part by communicating with an AICP server.

At step 204, the method 200 further includes selecting an AICP endpoint that matches the AICP endpoint search query from among a plurality of AICP endpoints. Selecting the AICP endpoint that matches the AICP endpoint search query may include searching over an AICP endpoint registry. For example, the search may be a vector similarity search over sets of registered local applications and registered remote applications specified in the AICP endpoint registry.

Steps 206, 208, 210, and 212 are performed at an AICP proxy service. The AICP proxy service may be executed at the same computing device as the AICP client. At step 206, the method 200 may include sending and receiving AICP traffic between the AICP client and the selected AICP endpoint that was identified as matching the AICP endpoint search query. The selected AICP endpoint may be a remote AICP endpoint server executed at a server device that communicates with the client device over a network. The AICP traffic includes one or more AICP requests transmitted from the AICP client to the selected AICP endpoint, as well as one or more AICP responses received at the AICP client from the selected AICP endpoint. In some examples, sending and receiving the AICP traffic at step 206 may include performing NAT on the one or more AICP requests.

At step 208, the method 200 further includes enforcing a request policy on the one or more AICP requests, and/or enforcing a response policy on the one or more AICP responses. In some examples, at step 210, enforcing a policy at step 208 may include determining whether the selected AICP endpoint is included in a registry of AICP endpoints registered with the AICP proxy service. In such examples, the AICP proxy service may allow further processing of the AICP request or response subsequently to determining that the associated AICP endpoint is included in the registry. In some examples, enforcing the request policy and/or the response policy may include performing deep packet inspection on the one or more AICP requests and/or the one or more AICP responses at the AICP proxy service.

At step 212, the method 200 may further include storing the AICP traffic in a proxy service log. Accordingly, the AICP proxy service may maintain records of the one or more AICP requests and the one or more AICP responses. Stored AICP requests and/or responses may, for example, be subjected to auditing or may be used to diagnose errors.

At step 214, the method 200 further includes computing a generated output at the one or more ML models included in the generative system based at least in part on the one or more AICP responses. At step 216, the method 200 further includes outputting the generated output. For example, the generated output may be output to a user interface such as a GUI or an audio interface. As another example, the generated output may be used as synthetic data to train an ML model.

FIGS. 7B-7F show additional steps of the method 200 that may be performed in some examples. FIG. 7B shows steps that may be performed at the AICP proxy service. At step 218, the method 200 may further include enforcing the request policy at least in part by performing one or more corresponding request validation checks on the one or more AICP requests. For example, the one or more request validation checks may include a payload confidentiality check, a user permission check, and/or the registry inclusion check discussed above. At step 220, the method 200 may further include transmitting the one or more AICP requests to the selected AICP endpoint in response to determining that the one or more AICP requests pass the one or more request validation checks.

FIG. 7C shows additional steps of the method 200 that may be performed at the AICP proxy service in some examples. At step 222, the method 200 may further include enforcing the response policy at least in part by performing one or more corresponding response validation checks on the one or more AICP responses. The one or more response validation checks may, for example, include a user permission check, a registry inclusion check, and/or a malicious code check. At step 224, the method 200 may further include transmitting the one or more AICP responses to the AICP client in response to determining that the one or more AICP responses pass the one or more response validation checks.

FIG. 7D shows steps that may be performed in order to allow a user to set the request policy and/or the response policy. At step 226, the method 200 may further include receiving a proxy policy specification via a user interface. At step 228, the method 200 may further include enforcing the request policy and/or the response policy at the AICP proxy service as specified by the proxy policy specification.

FIG. 7E shows additional steps that may be performed at the AICP proxy service in examples in which the AICP traffic includes a plurality of AICP requests and a plurality of AICP responses. At step 230, the method 200 may further include performing traffic shaping on the plurality of AICP requests and the plurality of AICP responses. For example, at step 232, performing the traffic shaping at step 230 may include performing a prioritize operation, a delay operation, a bandwidth allocation operation, or a traffic dropping operation on at least a portion of the AICP traffic.

FIG. 7F shows additional steps of the method 200 that may be performed in some examples to compute the AICP endpoint registry. At step 234, the method 200 may further include registering one or more of the AICP endpoints with the AICP proxy service. Registering the AICP endpoint may include, at step 236, sending and receiving test AICP traffic between the AICP proxy service and the AICP endpoint. The test AICP traffic may include a plurality of test AICP requests and a plurality of test AICP responses. At step 238, registering the AICP endpoint may further include determining whether the test AICP traffic satisfies the request policy and/or the response policy. At step 240, the method 200 may further include registering the AICP endpoint with the AICP proxy service in response to determining that the test AICP traffic satisfies the request policy and/or the response policy. By performing the steps of FIG. 7F for a plurality of different AICP endpoints, a registry of verified AICP endpoints may be constructed at the AICP proxy service.

According to the systems and methods discussed above, an AICP proxy service is executed. This AICP proxy service may be used to implement a request policy that is applied to outgoing AICP requests and/or a response policy that is applied to incoming AICP responses. The request policy and/or response policy may be used to perform security and compliance checks on AICP traffic. For example, when the one or more processing devices perform an endpoint search to select an AICP endpoint that matches a search query, the AICP endpoint may be an application program that performs unknown, and potentially unwanted, computing processes. The request policy and/or response policy may be used in such examples to enforce security and/or compliance rules. The AICP endpoint may also be tested with test AICP traffic and may be added to an AICP endpoint registry if it passes.

Traffic shaping may also be performed at the AICP proxy service. The one or more processing devices may be configured to execute the AICP proxy service to perform traffic shaping operations such as prioritization and bandwidth allocation to thereby utilize computing resources more efficiently at the AICP client and one or more AICP endpoints.

The methods and processes described herein are tied to a computing system of one or more computing devices. In particular, such methods and processes can be implemented as a computer-application program or service, an application-programming interface (API), a library, and/or other computer-program product.

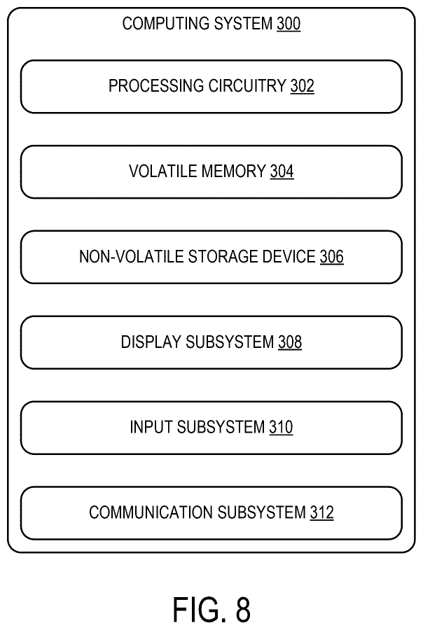

FIG. 8 schematically shows a non-limiting embodiment of a computing system 300 that can enact one or more of the methods and processes described above. Computing system 300 is shown in simplified form. Computing system 300 may instantiate the computing system 10 discussed above with reference to FIG. 1. Components of computing system 300 may be included in one or more personal computers, server computers, tablet computers, home-entertainment computers, network computing devices, video game devices, mobile computing devices, mobile communication devices (e.g., smartphone), and/or other computing devices, and wearable computing devices such as smart wristwatches and head mounted augmented reality devices.

Computing system 300 includes processing circuitry 302, volatile memory 304, and a non-volatile storage device 306. Computing system 300 may optionally include a display subsystem 308, input subsystem 310, communication subsystem 312, and/or other components not shown in FIG. 8.

Processing circuitry 302 typically includes one or more logic processors, which are physical devices configured to execute instructions. For example, the logic processors may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors configured to execute software instructions. Additionally or alternatively, the logic processor may include one or more hardware logic circuits or firmware devices configured to execute hardware-implemented logic or firmware instructions. Processors of the processing circuitry 302 may be single-core or multi-core, and the instructions executed thereon may be configured for sequential, parallel, and/or distributed processing. Individual components of the processing circuitry 302 optionally may be distributed among two or more separate devices, which may be remotely located and/or configured for coordinated processing. For example, aspects of the computing system 300 disclosed herein may be virtualized and executed by remotely accessible, networked computing devices configured in a cloud-computing configuration. In such a case, these virtualized aspects are run on different physical logic processors of various different machines, it will be understood. These different physical logic processors of the different machines will be understood to be collectively encompassed by processing circuitry 302.

Non-volatile storage device 306 includes one or more physical devices configured to hold instructions executable by the processing circuitry 302 to implement the methods and processes described herein. When such methods and processes are implemented, the state of non-volatile storage device 306 may be transformed—e.g., to hold different data.

Non-volatile storage device 306 may include physical devices that are removable and/or built in. Non-volatile storage device 306 may include optical memory, semiconductor memory, and/or magnetic memory, or other mass storage device technology. Non-volatile storage device 306 may include nonvolatile, dynamic, static, read/write, read-only, sequential-access, location-addressable, file-addressable, and/or content-addressable devices. It will be appreciated that non-volatile storage device 306 is configured to hold instructions even when power is cut to the non-volatile storage device 306.

Volatile memory 304 may include physical devices that include random access memory. Volatile memory 304 is typically utilized by processing circuitry 302 to temporarily store information during processing of software instructions. It will be appreciated that volatile memory 304 typically does not continue to store instructions when power is cut to the volatile memory 304.

Aspects of processing circuitry 302, volatile memory 304, and non-volatile storage device 306 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 300 typically implemented in software by a processor to perform a particular function using portions of volatile memory, which function involves transformative processing that specially configures the processor to perform the function. Thus, a module, program, or engine may be instantiated via processing circuitry 302 executing instructions held by non-volatile storage device 306, using portions of volatile memory 304. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 308 may be used to present a visual representation of data held by non-volatile storage device 306. The visual representation may take the form of a graphical user interface (GUI). As the herein described methods and processes change the data held by the non-volatile storage device 306, and thus transform the state of the non-volatile storage device 306, the state of display subsystem 308 may likewise be transformed to visually represent changes in the underlying data. Display subsystem 308 may include one or more display devices utilizing virtually any type of technology. Such display devices may be combined with processing circuitry 302, volatile memory 304, and/or non-volatile storage device 306 in a shared enclosure, or such display devices may be peripheral display devices.

When included, input subsystem 310 may comprise or interface with one or more user-input devices such as a keyboard, mouse, touch screen, camera, or microphone.

When included, communication subsystem 312 may be configured to communicatively couple various computing devices described herein with each other, and with other devices. Communication subsystem 312 may include wired and/or wireless communication devices compatible with one or more different communication protocols. As non-limiting examples, the communication subsystem 312 may be configured for communication via a wired or wireless local- or wide-area network, broadband cellular network, etc. In some embodiments, the communication subsystem 312 may allow computing system 500 to send and/or receive messages to and/or from other devices via a network such as the Internet.

The following paragraphs discuss several aspects of the present disclosure. According to one aspect of the present disclosure, a computing system is provided, including one or more processing devices configured to receive an artificial intelligence context protocol (AICP) endpoint search query from a generative system executed at an AICP client. The generative system includes one or more machine learning (ML) models. The one or more processing devices are further configured to select an AICP endpoint that matches the AICP endpoint search query from among a plurality of AICP endpoints. At an AICP proxy service, the one or more processing devices are further configured to send and receive AICP traffic between the AICP client and the selected AICP endpoint. The AICP traffic includes one or more AICP requests and one or more AICP responses. The one or more processing devices are further configured to enforce a request policy on the one or more AICP requests, and/or enforce a response policy on the one or more AICP responses. At the one or more ML models included in the generative system, the one or more processing devices are further configured to compute a generated output based at least in part on the one or more AICP responses. The one or more processing devices are further configured to output the generated output. The above features may have the technical effect of performing security and/or compliance checks on the AICP traffic.

According to this aspect, at the AICP proxy service, the one or more processing devices may be further configured to enforce the request policy at least in part by performing one or more corresponding request validation checks on the one or more AICP requests. The one or more processing devices may be further configured to transmit the one or more AICP requests to the selected AICP endpoint in response to determining that the one or more AICP requests pass the one or more request validation checks. The above features may have the technical effect of checking security and/or confidentiality properties of the one or more AICP requests prior to sending.

According to this aspect, for each of the one or more AICP requests, the one or more processing devices are configured to perform the request validation check at least in part by determining whether a request payload of the AICP request is marked as confidential. The above features may have the technical effect of avoiding unauthorized transmission of confidential data in the one or more AICP requests.

According to this aspect, at the AICP proxy service, the one or more processing devices may be further configured to enforce the response policy at least in part by performing one or more corresponding response validation checks on the one or more AICP responses. The one or more processing devices may be further configured to transmit the one or more AICP responses to the AICP client in response to determining that the one or more AICP responses pass the one or more response validation checks. The above features may have the technical effect of checking security and/or confidentiality properties of the one or more AICP responses prior to processing the one or more AICP responses at the AICP client.

According to this aspect, the one or more processing devices may be further configured to receive a proxy policy specification via a user interface. The one or more processing devices may be further configured to enforce the request policy and/or the response policy at the AICP proxy service as specified by the proxy policy specification. The above features may have the technical effect of allowing the user to specify the request policy and/or the response policy.

According to this aspect, the one or more processing devices may be configured to enforce the request policy and/or the response policy at least in part by determining whether the selected AICP endpoint is included in a registry of AICP endpoints registered with the AICP proxy service. The above features may have the technical effect of determining whether the AICP traffic is sent to and/or received from an approved AICP endpoint.

According to this aspect, the one or more processing devices may be further configured to register one or more of the AICP endpoints with the AICP proxy service at least in part by sending and receiving test AICP traffic between the AICP proxy service and the AICP endpoint. The test AICP traffic may include a plurality of test AICP requests and a plurality of test AICP responses. Registering the one or more AICP endpoints may further include determining whether the test AICP traffic satisfies the request policy and/or the response policy. Registering the one or more AICP endpoints may further include registering the AICP endpoint with the AICP proxy service in response to determining that the test AICP traffic satisfies the request policy and/or the response policy. The above features may have the technical effect of adding an AICP endpoint to the registry when traffic with that AICP endpoint is determined to comply with the request policy and/or the response policy.

According to this aspect, at the AICP proxy service, the one or more processing devices may be further configured to store the AICP traffic in a proxy service log. The above features may have the technical effect of storing the AICP traffic for monitoring and/or compliance.

According to this aspect, the AICP traffic may include a plurality of AICP requests and a plurality of AICP responses. At the AICP proxy service, the one or more processing devices may be further configured to perform traffic shaping on the plurality of AICP requests and the plurality of AICP responses. The above features may have the technical effect of reducing latency and avoiding bottlenecks in AICP request and response processing.

According to this aspect, the traffic shaping may include a prioritize operation, a delay operation, a bandwidth allocation operation, or a traffic dropping operation that is performed on at least a portion of the AICP traffic. The above features may have the technical effect of performing the traffic shaping.

According to another aspect of the present disclosure, a method for use with a computing system is provided. The method includes receiving an artificial intelligence context protocol (AICP) endpoint search query from a generative system executed at an AICP client. The generative system includes one or more machine learning (ML) models. The method further includes selecting an AICP endpoint that matches the AICP endpoint search query from among a plurality of AICP endpoints. At an AICP proxy service, the method further includes sending and receiving AICP traffic between the AICP client and the selected AICP endpoint. The AICP traffic includes one or more AICP requests and one or more AICP responses. The method further includes enforcing a request policy on the one or more AICP requests, and/or enforcing a response policy on the one or more AICP responses. At the one or more ML models included in the generative system, the method further includes computing a generated output based at least in part on the one or more AICP responses. The method further includes outputting the generated output. The above features may have the technical effect of performing security and/or compliance checks on the AICP traffic.

According to this aspect, at the AICP proxy service, the method may further include enforcing the request policy at least in part by performing one or more corresponding request validation checks on the one or more AICP requests. The method may further include transmitting the one or more AICP requests to the selected AICP endpoint in response to determining that the one or more AICP requests pass the one or more request validation checks. The above features may have the technical effect of checking security and/or confidentiality properties of the one or more AICP requests prior to sending.

According to this aspect, at the AICP proxy service, the method may further include enforcing the response policy at least in part by performing one or more corresponding response validation checks on the one or more AICP responses. The method may further include transmitting the one or more AICP responses to the AICP client in response to determining that the one or more AICP responses pass the one or more response validation checks. The above features may have the technical effect of checking security and/or confidentiality properties of the one or more AICP responses prior to processing the one or more AICP responses at the AICP client.

According to this aspect, the method may further include receiving a proxy policy specification via a user interface. The method may further include enforcing the request policy and/or the response policy at the AICP proxy service as specified by the proxy policy specification. The above features may have the technical effect of allowing the user to specify the request policy and/or the response policy.

According to this aspect, enforcing the request policy and/or the response policy may include determining whether the selected AICP endpoint is included in a registry of AICP endpoints registered with the AICP proxy service. The above features may have the technical effect of determining whether the AICP traffic is sent to and/or received from an approved AICP endpoint.

According to this aspect, registering one or more of the AICP endpoints with the AICP proxy service may further include sending and receiving test AICP traffic between the AICP proxy service and the AICP endpoint. The test AICP traffic may include a plurality of test AICP requests and a plurality of test AICP responses. Registering the one or more AICP endpoints may further include determining whether the test AICP traffic satisfies the request policy and/or the response policy. Registering the one or more AICP endpoints may further include registering the AICP endpoint with the AICP proxy service in response to determining that the test AICP traffic satisfies the request policy and/or the response policy. The above features may have the technical effect of adding an AICP endpoint to the registry when traffic with that AICP endpoint is determined to comply with the request policy and/or the response policy.

According to this aspect, the method may further include, at the AICP proxy service, storing the AICP traffic in a proxy service log. The above features may have the technical effect of storing the AICP traffic for monitoring and/or compliance.

According to this aspect, the AICP traffic may include a plurality of AICP requests and a plurality of AICP responses. The method may further include, at the AICP proxy service, performing traffic shaping on the plurality of AICP requests and the plurality of AICP responses. The above features may have the technical effect of reducing latency and avoiding bottlenecks in AICP request and response processing.

According to this aspect, performing the traffic shaping may include performing a prioritize operation, a delay operation, a bandwidth allocation operation, or a traffic dropping operation on at least a portion of the AICP traffic. The above features may have the technical effect of performing the traffic shaping.

According to another aspect of the present disclosure, a computing system is provided, including one or more processing devices configured to, at an artificial intelligence context protocol AICP proxy service, send and receive AICP traffic between an AICP client and an AICP endpoint. The generative system includes one or more machine learning (ML) models. The AICP traffic includes a plurality of AICP requests computed at the generative system and a plurality of AICP responses received at the generative system. The one or more processing devices are further configured to perform traffic shaping on the plurality of AICP requests and the plurality of AICP responses. The one or more processing devices are further configured to enforce a request policy on the plurality of AICP requests, and/or enforce a response policy on the plurality of AICP responses. At the one or more ML models included in the generative system, the one or more processing devices are further configured to compute a generated output based at least in part on the plurality of AICP responses. The one or more processing devices are further configured to output the generated output. The above features may have the technical effect of performing traffic shaping and security and/or compliance checks on the AICP traffic.

“And/or” as used herein is defined as the inclusive or V, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system comprising:
one or more processing devices configured to:
receive an artificial intelligence context protocol (AICP) endpoint search query from a generative system executed at an AICP client, wherein the generative system includes one or more machine learning (ML) models;
select an AICP endpoint that matches the AICP endpoint search query from among a plurality of AICP endpoints;
at an AICP proxy service:
send and receive AICP traffic between the AICP client and the selected AICP endpoint, wherein the AICP traffic includes one or more AICP requests and one or more AICP responses; and
enforce a request policy on the one or more AICP requests, and/or enforce a response policy on the one or more AICP responses;
at the one or more ML models included in the generative system, compute a generated output based at least in part on the one or more AICP responses; and
output the generated output.

2. The computing system of claim 1, wherein, at the AICP proxy service, the one or more processing devices are further configured to:
enforce the request policy at least in part by performing one or more corresponding request validation checks on the one or more AICP requests; and
transmit the one or more AICP requests to the selected AICP endpoint in response to determining that the one or more AICP requests pass the one or more request validation checks.

3. The computing system of claim 2, wherein, for each of the one or more AICP requests, the one or more processing devices are configured to perform the request validation check at least in part by determining whether a request payload of the AICP request is marked as confidential.

4. The computing system of claim 1, wherein, at the AICP proxy service, the one or more processing devices are further configured to:
enforce the response policy at least in part by performing one or more corresponding response validation checks on the one or more AICP responses; and
transmit the one or more AICP responses to the AICP client in response to determining that the one or more AICP responses pass the one or more response validation checks.

5. The computing system of claim 1, wherein the one or more processing devices are further configured to:
receive a proxy policy specification via a user interface; and
enforce the request policy and/or the response policy at the AICP proxy service as specified by the proxy policy specification.

6. The computing system of claim 1, wherein the one or more processing devices are configured to enforce the request policy and/or the response policy at least in part by determining whether the selected AICP endpoint is included in a registry of AICP endpoints registered with the AICP proxy service.

7. The computing system of claim 6, wherein the one or more processing devices are further configured to register one or more of the AICP endpoints with the AICP proxy service at least in part by:
sending and receiving test AICP traffic between the AICP proxy service and the AICP endpoint, wherein the test AICP traffic includes a plurality of test AICP requests and a plurality of test AICP responses;
determining whether the test AICP traffic satisfies the request policy and/or the response policy; and
registering the AICP endpoint with the AICP proxy service in response to determining that the test AICP traffic satisfies the request policy and/or the response policy.

8. The computing system of claim 1, wherein, at the AICP proxy service, the one or more processing devices are further configured to store the AICP traffic in a proxy service log.

9. The computing system of claim 1, wherein:
the AICP traffic includes a plurality of AICP requests and a plurality of AICP responses; and
at the AICP proxy service, the one or more processing devices are further configured to perform traffic shaping on the plurality of AICP requests and the plurality of AICP responses.

10. The computing system of claim 9, wherein the traffic shaping includes a prioritize operation, a delay operation, a bandwidth allocation operation, or a traffic dropping operation that is performed on at least a portion of the AICP traffic.

11. A method for use with a computing system, the method comprising:
receiving an artificial intelligence context protocol (AICP) endpoint search query from a generative system executed at an AICP client, wherein the generative system includes one or more machine learning (ML) models;
selecting an AICP endpoint that matches the AICP endpoint search query from among a plurality of AICP endpoints;
at an AICP proxy service:
sending and receiving AICP traffic between the AICP client and the selected AICP endpoint, wherein the AICP traffic includes one or more AICP requests and one or more AICP responses; and
enforcing a request policy on the one or more AICP requests, and/or enforcing a response policy on the one or more AICP responses;
at the one or more ML models included in the generative system, computing a generated output based at least in part on the one or more AICP responses; and
outputting the generated output.

12. The method of claim 11, further comprising, at the AICP proxy service:
enforcing the request policy at least in part by performing one or more corresponding request validation checks on the one or more AICP requests; and
transmitting the one or more AICP requests to the selected AICP endpoint in response to determining that the one or more AICP requests pass the one or more request validation checks.

13. The method of claim 11, further comprising, at the AICP proxy service:
enforcing the response policy at least in part by performing one or more corresponding response validation checks on the one or more AICP responses; and
transmitting the one or more AICP responses to the AICP client in response to determining that the one or more AICP responses pass the one or more response validation checks.

14. The method of claim 11, further comprising:
receiving a proxy policy specification via a user interface; and
enforcing the request policy and/or the response policy at the AICP proxy service as specified by the proxy policy specification.

15. The method of claim 11, wherein enforcing the request policy and/or the response policy includes determining whether the selected AICP endpoint is included in a registry of AICP endpoints registered with the AICP proxy service.

16. The method of claim 15, further comprising registering one or more of the AICP endpoints with the AICP proxy service at least in part by:
sending and receiving test AICP traffic between the AICP proxy service and the AICP endpoint, wherein the test AICP traffic includes a plurality of test AICP requests and a plurality of test AICP responses;
determining whether the test AICP traffic satisfies the request policy and/or the response policy; and
registering the AICP endpoint with the AICP proxy service in response to determining that the test AICP traffic satisfies the request policy and/or the response policy.

17. The method of claim 11, further comprising, at the AICP proxy service, storing the AICP traffic in a proxy service log.

18. The method of claim 11, wherein:
the AICP traffic includes a plurality of AICP requests and a plurality of AICP responses; and
the method further comprises, at the AICP proxy service, performing traffic shaping on the plurality of AICP requests and the plurality of AICP responses.

19. The method of claim 18, wherein performing the traffic shaping includes performing a prioritize operation, a delay operation, a bandwidth allocation operation, or a traffic dropping operation on at least a portion of the AICP traffic.

20. A computing system comprising:
one or more processing devices configured to:
at an artificial intelligence context protocol (AICP) proxy service:
send and receive AICP traffic between an AICP client and an AICP endpoint, wherein:
the generative system includes one or more machine learning (ML) models; and
the AICP traffic includes a plurality of AICP requests computed at the generative system and a plurality of AICP responses received at the generative system;
perform traffic shaping on the plurality of AICP requests and the plurality of AICP responses; and
enforce a request policy on the plurality of AICP requests, and/or enforce a response policy on the plurality of AICP responses;
at the one or more ML models included in the generative system, compute a generated output based at least in part on the plurality of AICP responses; and
output the generated output.
